(19) United States
(12) Patent Application Publication
(10) Pub. No.: US 2024/0238811 A1
(43) Pub. Date: Jul. 18, 2024

(54) Tandem Shower

(71) Applicant: Cara Ann Recine, Santa Rosa, CA (US)

(72) Inventor: Cara Ann Recine, Santa Rosa, CA (US)

(21) Appl. No.: 18/098,297

(22) Filed: Jan. 18, 2023

(51) Int. Cl. B05B 1/18

(52) U.S. Cl. CPC B05B 1/185

(57) ABSTRACT

The present invention discloses an advance assembly with dual shower system which is easy to use and easy to install. The assembly provides complete configuration, is rotatable to 360 degree and sustains its quality and effectiveness over longer period of time.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

This relates to enabling more than one individual to take a shower at the same time, using one shower bar. It also provides a height adjustment for the shower bar, as well as swivel showerheads for ease and comfort of use. In addition to swiveling, the showerheads are capable of being horizontally positioned along the bar. With this device people who need to raise the height of the shower as well as people who need to sit when in the shower can be accommodated.

### Description of the Related Art

Bathing and shower can wash away a whole day of worry and tiredness, and people would be revitalized with refreshment and energy. Therefore, appliances or devices of bathing and shower have potential markets. Moreover, as the price of land is increasingly high, shower devices that are less space-consuming become more popular among the users.

By looking at prior art multiple advancements have been seen in similar regards. For instance, a Dual shower head assembly bearing U.S. Pat. No. 4,901,927A shows a dual shower head assembly for use in personal showers to allow two people to shower independently at the same time, one person to shower in a conventional manner or one person to shower with two separate sprays. The assembly includes an upper shower head, a lower shower head, a substantially “S”-shaped connecting conduit, a diverter valve assembly and an adjustable shut-off valve. The diverter valve assembly is adapted for threaded engagement with the water supply pipe protruding from the shower wall and defines a pair of water outlets, one of which communicates with and is pivotally connected to the lower end of the connecting conduit. The shut-off valve is carried by the diverter valve assembly and communicates with the other of the water outlets in the diverter valve for selectively allowing water flow therethrough. The lower shower head communicates with and is pivotally mounted on the shut-off valve, downstream of the diverter valve. The upper shower head communicates with and is pivotally mounted on the upper end of the connecting conduit. The diverter valve restricts the flow of water and selectively allows water passing therethrough from the water supply pipe to flow only to the shut-off valve or both to the shut-off valve and to the connecting conduit whereby through the coordination of the diverter valve assembly and the shut-off valve, water can be directed to spray only through said lower first shower head, only through said upper shower head, through both shower heads concurrently or through neither shower head. The pivotal mounting of the individual shower heads and “S”-shaped configuration of the connecting conduit provides a substantial flexibility in the positioning of the water spray or sprays for one or two persons.

A U.S. Pat. No. 9,095,861B2 discloses Dual shower head assembly. Because the height of humans will vary it is important to be able to adjust the height of the showerhead. At times it may also be useful to be able to have two people shower at the same time and be able to adjust the distance between the two showerheads to accommodate the distance between two people. It may also be useful for the showerhead to be portable and easily attached and reattached to the water supply for the shower.

A U.S. Pat. No. 5,564,139A discusses Dual shower head assembly. A shower head assembly for simultaneously showering both front and back portions of a person's body without a person receiving the force of the shower spray in the face. The device can be used by both small children and adults due to a unique orientation and separation of the shower heads with respect to an overhead supply line.

Another US patent 2,011,0010840A1 discloses Dual-head shower assembly. The present invention relates to a dual shower head assembly and a method of installing where the head assembly includes: a first shower head; a mechanism to split water supply into the first shower head; a second shower head, where the second shower head is opposed to the first shower head; a water supply pipe connector, where said pipe connector connects the second shower head to the means to split the water supply; and a mechanism to hang a shower curtain on the shower head assembly. The pipe connector may provide the mechanism to hang a shower curtain. In one particular embodiment, a splitter connected above the first shower head provides the mechanism to split the water supply.

A U.S. Pat. No. 5,799,346A discloses Dual shower head device. A dual shower head device having elongated tubular sections that are connected in a telescopic manner to form an elongated unit is disclosed. The elongated telescoping tubes serve to adjust the length of the device to fit a particular tub/shower enclosure, to aid in securing the unit in place between opposite walls of the enclosure, and to allow the unit to be compressed for ease in installing and positioning the unit in place between the walls, and to provide a conduit for moving water. A helical spring is compressed within the tubular unit and serves to urge the tubular sections apart and to secure the device between the walls of the enclosure. Rubber bumpers are secured to the ends of the unit for contacting the walls of the enclosure and a shower head is mounted at one end and directed inward and a second shower head is secured to a diverter which is connected to the conventional shower pipe and, via a flexible hose, to the unit. The diverter is manually controlled to apply water to the first shower head, or to both shower heads at the same time.

U.S. Pat. No. 3,121,235 discloses a multiple-head shower assembly that includes up to four showerheads assembled along a vertical configuration where two showerheads provide upper streams of water and two additional showerheads below the centerline thereof provide lower streams of water. U.S. Pat. No. 3,822,826 discloses an attachment device that converts a single showerhead to a dual opposed showerhead assembly where the showering is provided at each side of the shower enclosure.

U.S. Pat. No. 5,564,139 discloses a showerhead assembly for simultaneously showering the front and back portions of a person's body without the person receiving the force of the shower spray directed toward their face. The showerhead assembly of the '139 patent includes an orientation where showerheads are separated with respect to the overhead supply line.

U.S. Pat. No. 6,415,461 discloses an adjustable shower assembly that provides multiple showerheads at various locations without the need for additional plumbing. The adjustable shower system of the '461 patent includes a plurality of connecting tubes and suction cups provided to maneuver the position of the showerheads as desired by the user.

A Double shower device bearing U.S. Pat. No. 1,096,8612B1 discloses NCIP Inc. A double shower device comprises a water inlet pipe, a first water separator, a first shower bar, a second shower bar, and a second water separator. The first water separator comprises a first water inlet end connected to the water inlet pipe, a first chamber connected to the first water inlet end, and a block member disposed in the first chamber to be moved vertically. The second water separator is connected to one end of the second shower bar opposite to the first water separator, and comprises a second water inlet end connected to the second shower bar, a second chamber connected to the second water inlet end, and a valve member disposed in the second chamber. The valve member comprises an open state and a close state for moving the block member downward and upward respectively to force a water flow to flow downward and upward respectively.

There are multiple solutions that have been presented in prior art in regarding efficient showering equipment which aim on providing luxury to users while added comfort. However, the utility of these systems has not been seen in advance form and for the above discussed needs. Looking at the prior art and market requirements, the need exists for an advancement that allows better showering system. The proposed invention introduces a system which is a dual shower system, is easy to install and easy to use.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

It is therefore an object of this invention to provide a new and improved dual shower head assembly capable of providing dual shower sprays.

It is another object to provide an improved dual shower head device of the elongated type that includes a unit that extends between opposite walls of a tub or shower enclosure

It is another object to provide improved structure to solve the problem of complicated structures and high cost of the conventional techniques.

It is also the objective of the system to provide an assembly which is designed to provide maximum cost benefit and timesaving, by providing dual shower system.

According to another aspect, it is also the objective of the invention to provide an assembly which can be assembled or disassembled easily.

It is also the objective of the system to provide an assembly which is compact and only uses one square foot of floor space.

It is also the objective of the invention to provide an assembly which is of durable configuration made of high-quality material. The inner parts of the assembly can sustain the high temperature and repeated usage.

Other aspects, advantages and novel features of the present invention will become apparent from the detailed description of the invention when considered in conjunction with the accompanying drawings.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 discloses the closeup view of assembly as per preferred embodiments of the invention.

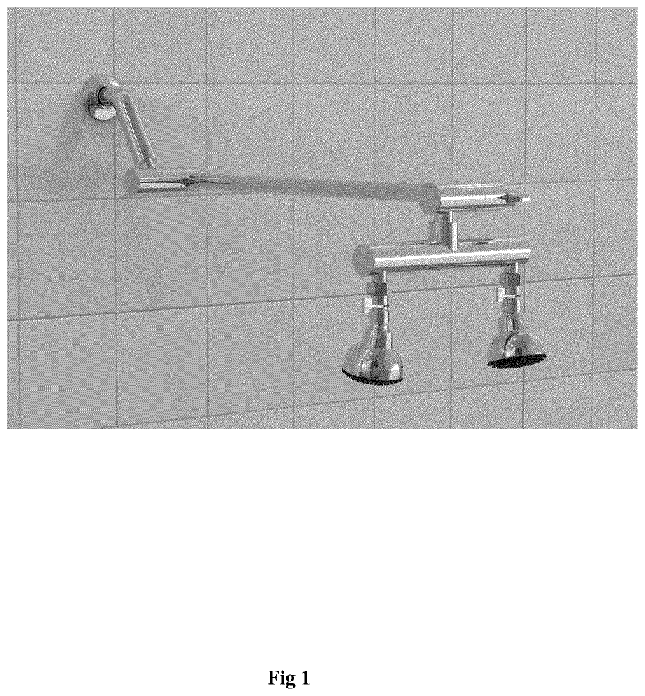

FIG. 2 discloses the closeup view of motor as per preferred embodiments of the invention.

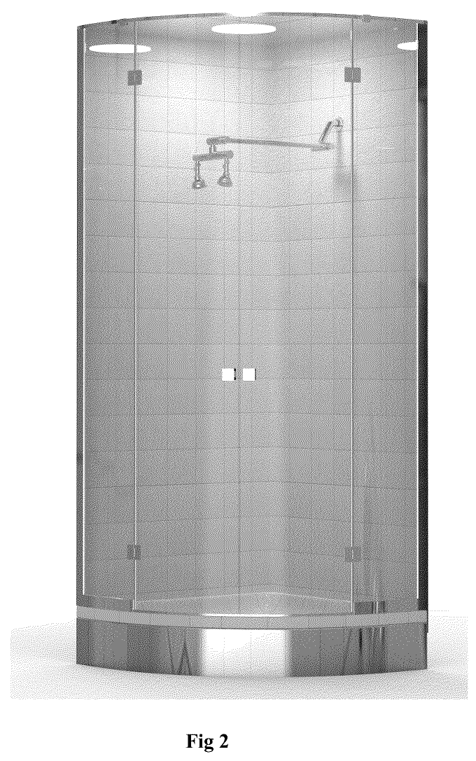

FIG. 3 discloses another complete view involved in configuration of proposed assembly as per preferred embodiments of the invention.

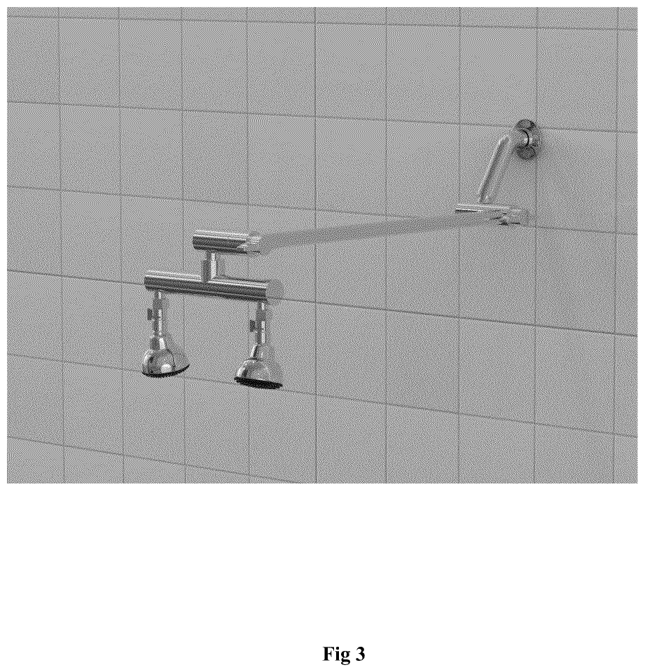

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present invention is directed to provides a dual shower system which provides ease and convenience to the user.

The invention as per preferred embodiment presents a system The device will be comprised of a shower rod through which a first interior cylindrical pipe and second interior cylindrical pipe are placed. The first interior cylindrical pipe is positioned closer to the end of the shower rod where the water is supplied through the interior water source coming from the home. The interior water source is connected to the water line from the house. Water will flow from the interior water source to the first interior cylindrical pipe that is positioned inside the shower rod. However, an additional interior flexible hose could attach the interior water source to the first interior cylindrical pipe. The first interior cylindrical pipe is connected to the second interior cylindrical pipe by an interior flexible hose. Attached to the interior cylindrical pipe is a showerhead.

Water will be permitted to flow through the interior water source, the first interior cylindrical pipe, the interior flexible hose, the second interior cylindrical pipe, and the showerhead(s) respectively, to bathe the person(s) taking the shower.

Each of the showerheads will have a means to regulate the flow of water through each showerhead, independent of each other. Each showerhead will have a valve, which operates independently of each other. This allows the user the option of using all showerheads or to use one showerhead if he or she desires. Each of the showerheads will have the ability to swivel so that the individual can direct the flow of water as desired.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A dual showerhead assembly comprised of:
a shower rod;
wherein the shower rod is hollow;
wherein a means to connect the shower rod to the shower surface is provided;
wherein there is a means of lengthening the shower rod;
wherein the shower rod has a first end and a second end;
wherein a plurality of slots is provided on the surface of the shower rod; and, said plurality of slots permit the movement of the showerheads in a horizontal direction for a predetermined length.
